(19) United States
(12) Patent Application Publication
(10) Pub. No.: US 2014/0025317 A1
(43) Pub. Date: Jan. 23, 2014

(54) PRESSURE GUIDING TUBE BLOCKAGE DIAGNOSING DEVICE AND BLOCKAGE DIAGNOSING METHOD

(71) Applicant: AZBIL CORPORATION, Tokyo (JP)

(72) Inventors: Youhei SATOU, Tokyo (JP); Tetsuya TABARU, Tokyo (JP); Masato TANAKA, Tokyo (JP)

(73) Assignee: AZBIL CORPORATION, TOKYO (JP)

(21) Appl. No.: 13/945,346

(22) Filed: Jul. 18, 2013

(30) Foreign Application Priority Data
Jul. 18, 2012 (JP) 2012-159328

(51) Int. Cl. G01N 19/00

(52) U.S. Cl. CPC G01N 19/00
USPC 702/50

(57) ABSTRACT

A pressure guiding tube blockage diagnosing device includes a feature quantity calculating portion partitioning a time series of pressure data into intervals, and calculating, for each interval, a feature quantity indicating the state of pressure fluctuation, an indicator value calculating portion calculating, for each individual interval, an indicator value indicating a state of blockage of pressure guiding tubes, from the feature quantities for a given time interval up until that interval, a change rate calculating portion performing, for each interval, a smoothing process on the indicator values over a specific time interval up to that interval, and calculating, from the indicator values that have been subjected to the smoothing process, a change rate for the indicator values for each interval, and an evaluating portion evaluating the state of blockage of a pressure guiding tube based on a change rate of the indicator value calculated by the change rate calculating portion.

### CROSS REFERENCE TO RELATED APPLICATION

The present application claims priority under 35 U.S.C. §119 to Japanese Patent Application No. 2012-159328, filed Jul. 18, 2012, which is incorporated herein by reference in its entirety.

### FIELD OF TECHNOLOGY

The present invention relates to a pressure guiding tube blockage diagnosing device and blockage diagnosing method, for diagnosing a blockage in a pressure guiding tube for guiding, to a pressure detecting portion, a pressure to be measured, wherein there are fluctuations in the pressure.

### BACKGROUND

Conventionally, in the process industry field, pressure transmitting devices and differential pressure transmitting devices have been used in order to control processes by detecting, for example, the amounts of variations in processes. Pressure transmitting devices are also known as pressure forwarding devices, and differential pressure transmitting devices are also known as differential pressure forwarding devices. A pressure transmitting device measures an absolute pressure or a gauge pressure, and a differential pressure transmitting device measures a pressure difference between two points, and they are used to measure variable quantities in processes such as pressure, flow rate, fluid level, specific gravity, and so forth. Typically when a process variable quantity is measured using a pressure or differential pressure transmitting device (hereinafter termed simply a “transmitting device” when referred to in general), the pressure to be measured is guided to the transmitting device (the pressure detecting portion) through a thin tube, known as the pressure guiding tube, from the process tube in which is flowing a fluid that is to be measured.

In this type of device structure, blockages in the pressure guiding tubes may result from the adherence, to the interior of the pressure guiding tubes, of solid objects, or the like, by that which is being measured. If a pressure guiding tube becomes completely blocked, then it becomes impossible to measure the process variable quantities accurately, which can have a serious impact on the plant. However, because pressure is still transmitted to the transmitting device up until the point wherein the pressure guiding tube becomes completely blocked, the impact of the blockage tends to not appear in the process variable quantity measurement values.

Remote seal-type pressure transmitting devices wherein pressure guiding tubes are not required have been developed in response to this type of problem. However, an extremely large number of plants measure process variable quantities using pressure guiding tubes, and thus there is the need to be able to perform pressure guiding tube blockage diagnostic functions on-line.

In response to this problem, there have already been proposals for methods and devices for diagnosing blockages in pressure guiding tubes using pressure fluctuations in the fluid.

For example, the ability to detect a blockage in a pressure guiding tube from a reduction in the maximum fluctuation amplitude (the difference between the maximum value and the minimum value) of a pressure signal is shown in Japanese Examined Patent Application Publication H7-11473 (“the JP '473”).

Devices and methods for detecting and diagnosing blockages in pressure guiding tubes using the magnitudes of fluctuations in pressure or differential pressure, and using parameters calculated therefrom, are disclosed in Japanese Patent 3139597 (“the JP '597”) and Japanese Patent 3129121 (“the JP '121”).

A device and a method for diagnosing the state of a pressure guiding tube from a statistical quantity or a function that reflects the magnitude of the fluctuations, that being the standard deviation or the power spectrum density of the fluctuations, derived from a differential pressure, are disclosed in Japanese Unexamined Patent Application Publication 2002-538420 (“the JP '420”).

A device and method for diagnosing a blockage from the speed of fluctuations, such as the rising/falling frequency of the pressure fluctuations, are shown in Japanese Unexamined Patent Application Publication 2010-127893 (“the JP '893”). Note that the invention disclosed in the JP '893, although differing from the inventions disclosed in the JP '473, the JP '597, the JP '121 and the JP '420 in the point in that it is based on the speed (frequency) of the fluctuations rather than the amplitudes of the fluctuations in pressure or differential pressure, shares the point that it uses fluctuations in pressure or differential pressure.

However, in most of these conventional devices and methods for detecting blockages in pressure guiding tubes from fluctuations in pressure, there is a problem in that there is a certain amount of time lag produced between the occurrence of the blockage and the detection thereof. This time lag results from factors such as described below.

Many of the devices and methods for diagnosing blockages in pressure guiding tubes use fluctuations in pressure of a fluid. Because properties of a fluid (pressure or differential pressure) that are irregular signals are used as the data underlying the diagnostics, the “feature quantities (feature quantities indicating the state of fluctuation of the pressure)” that are produced by the pressure fluctuations (for example, the rising/falling frequency of the pressure fluctuations, first-order difference fluctuations (fluctuations calculated from the measured value the previous time Dp(i−1) and the measured value the current time Dp(i), that is Dp(i)−Dp(i−1)), or second-order difference fluctuations (the backward differences after the first-order difference fluctuations, that is, fluctuations calculated from the measured values the time before last, Dp(i−2), the measured values the previous time, Dp(i−1), and the measured values the current time, Dp(i), namely, Dp(i)−2Dp(i−1)+Dp(i−2)), and the like include variability other than that which is caused by a blockage. Because of this, the feature quantities are difficult to use as-is in diagnostics.

Given this, an “indicator value” (an indicator value indicating the state of blockage of the pressure guiding tube) calculated from the feature quantities over a specific time interval (for example, a moving average, over a specific interval, of the rising/falling frequency, the root mean square, over a specific interval, of a first-order difference fluctuation, the root mean square, over a specific interval, of a second-order difference fluctuation, or the like) is used in diagnostics.

If the time interval for calculating the indicator value is long, then the diagnostics will be accurate because of the ability to suppress variability in the indicator value. On the other hand, if time interval for calculating the indicator value is long, the time until the effects of a blockage will be reflected in the indicator value will be long. As a result, when attempts are made to secure some degree of accuracy in the diagnostics, some amount of time will be required until the effects of the blockage are reflected in the indicator value. Consequently, there is a given time lag between the occurrence of a blockage and the detection of the blockage.

If, at this time, the blockage progresses gradually enough then the time lag from the occurrence of the blockage to the detection of the blockage will be of a magnitude that can be ignored, so there will be no problem. However, if the blockage progresses rapidly, then the time lag from the occurrence of the blockage to the detection of the blockage will be of a magnitude that cannot be ignored.

The present invention was created in order to solve such a problem, and an aspect thereof is to provide a pressure guiding tube blockage diagnosing device and blockage diagnosing method able to reduce the time lag between the occurrence of a blockage and the detection of the blockage when a blockage progresses rapidly.

### SUMMARY

In order to achieve such an aspect, the present invention provides a pressure guiding tube blockage diagnosing device for diagnosing a blockage in a pressure guiding tube for guiding, to a pressure detecting portion, a pressure to be measured, wherein there are fluctuations in the pressure. The pressure guiding tube blockage diagnosing device includes a receiving portion that receives pressure data from the pressure detecting portion, a feature quantity calculating portion that partitions a time series of pressure data, receive by the receiving portion, into a plurality of intervals, and that calculates, for each interval, a feature quantity indicating the state of fluctuation of the pressure, an indicator value calculating portion that calculates, for each individual interval, an indicator value that indicates a state of blockage of the pressure guiding tubes, from the feature quantities for a given time interval up until that interval, a change rate calculating portion that performs, for each interval, a smoothing process on the indicator values over a specific time interval up to that interval, and calculates, from the indicator values that have been subjected to the smoothing process, a change rate for the indicator values for each interval, and an evaluating portion that evaluates the state of blockage of a pressure guiding tube based on a change rate of the indicator value calculated by the change rate calculating portion.

In order to reduce the time lag between the occurrence of a blockage and the detection of the blockage, occurring when the blockage progresses rapidly, the present invention focuses on the change rate of the indicator value that indicates the state of blockage of the pressure guiding tube. The circumstances leading up to this focus on the change rate of the indicator value are as described below. When a blockage progresses, the indicator value changes toward an abnormal range from a normal range. At this time, if the type of progress of the blockage is sudden, then even though there will be the time lag described above, the indicator value will change over a relatively short period of time. Changing over a short period of time means that even a change that would have a small difference when the indicator value is viewed would have a change rate that is a large value of a degree not normally seen. Moreover, often the point in time at which the change rate becomes large is a point in time that is prior to the indicator value reaching the abnormal range. The result is the understanding that it is possible to detect a rapidly progressing blockage more quickly through detecting a change rate having a larger value than normal in the indicator value than through detecting the indicator value going into the abnormal range.

Moreover, it struck the inventors that, rather than simply calculating the change rate of the indicator value, it would be effective to use a smoothing process, such as a moving average process or the least-squares method, to calculate the change rate after smoothing the indicator value over a given time width. The reasons why it is necessary to calculate the change rate after smoothing are the following. When calculating the change rate, there would be a problem in that the change rate that occurs only because of the blockage could not be calculated well by merely taking a simple difference (a forward difference or a backward difference). The reason for this is that variability in the data that is caused by dealing with a fluid (an irregular signal) is included in the indicator values. Even if the variability in the indicator values is low, when a difference (a forward difference or a backward difference) is simply calculated from the indicator value, often the variability in the difference will be appear larger than the difference in the indicator value.

As an example by which to explain the variability becoming large when taking a difference, let us consider data wherein the values in the range between −0.5 and 0.5, as illustrated in FIG. 16(a), are taken at random. The backward differences of the data shown in FIG. 16(a) will be as shown in FIG. 16(b), and the range thereof will be from −1 to 1, and the standard deviation thereof will also be larger than for the original data. Because there is such a problem, in order to use the change rate in detecting a blockage it is necessary to take only the change rate that occurs due to the blockage after removing the variability within the indicator value.

Calculating the change rate after smoothing makes it possible to take only the change in the indicator value that is due to the effect of the blockage in the pressure guiding tube, which is what is actually of interest, while eliminating the variability from an indicator value that has variability. In addition to focusing on the change rate of the indicator value, the ability to skillfully take only the change due to blockage of the pressure guiding tube from the change rate of the indicator value makes it possible to reduce the lag time between the occurrence of a blockage until the discovery of the blockage when the blockage progresses rapidly.

Note that while the state of blockage of the pressure guiding tube is evaluated based on the change rate of an indicator value, in the present invention the evaluation based on the change rate of the indicator value can be combined with an evaluation based on the indicator value. Doing so makes it possible to detect more quickly blockages over a wider range regardless of whether the progression of the blockage is slow or fast.

Note that in the present invention devices and means for detecting pressures and differential pressures, such as differential pressure transmitters and pressure transmitters, are termed, in general, “pressure detecting portions,” where the pressure data from a pressure detecting portion is defined as including differential pressure data. That is, if a pressure detecting portion detects a differential pressure, “pressure data” means a differential pressure between two points, where if the pressure detecting portion is that which detects pressure, “pressure data” means either an absolute pressure or a gauge pressure. In the present invention, not just absolute pressure or gauge pressure, but differential pressure as well, are included in “pressure data.”

Moreover, the present invention provides not only a pressure guiding tube blockage diagnosing device, but also provides a pressure guiding tube blockage diagnosing method.

Given the present invention, the time series of the pressure data received from the receiving portion is partitioned into a plurality of intervals, a feature quantity indicating the state of fluctuation of the pressure is calculated for each interval, an indicator value indicating the state of blockage of the pressure guiding tube is calculated from the feature quantities over a specific time interval up until that interval for each individual interval, a smoothing process for smoothing the indicator values over a specific time interval up until that interval is performed for each individual interval, a change rate indicating a change in the state of blockage of the pressure guiding tube is calculated for each interval from the indicator values on which the smoothing process has been performed, and the state of blockage of the pressure guiding tube is evaluated based on the calculated change rate, and thus only the change in the indicator value due to the effect of blockage of the pressure guiding tube, which is the actual interest, is taken, making it possible to reduce the time lag from the occurrence of a blockage to the detection of the blockage when a blockage progresses suddenly.

### BRIEF DESCRIPTIONS OF THE DRAWINGS

FIG. 1 is a schematic diagram illustrating one example of a differential pressure measuring system using a pressure guiding tube blockage diagnosing device according to the present invention.

FIG. 2 is a block diagram illustrating certain portions of an example of a pressure guiding tube blockage diagnosing device according to the present invention.

FIG. 3 is a diagram illustrating actual differential pressure data measured when an artificial blockage occurred in the pressure guiding tube of the differential pressure measuring system illustrated in FIG. 1.

FIG. 4 is a diagram illustrating the state wherein feature quantities are calculated by the feature quantity calculating portion in the example.

FIG. 5 is a diagram illustrating the state wherein indicator values are calculated by the indicator value calculating portion in the example.

FIG. 6 is a diagram illustrating the state of calculation of the change rate of the indicator value by the change rate calculating portion in the example.

FIG. 7 is a diagram illustrating changes in the change rate of the indicator value calculated by performing a smoothing process (a moving average process) by the change rate calculating portion in the example.

FIG. 8 is a diagram illustrating changes in the change rate of the indicator value calculated as simple backward differences, without performing a smoothing process.

FIG. 9 is a diagram illustrating a method for calculating the backward differences of the indicator values, for reference.

FIG. 10 is a diagram illustrating the changes in the indicator values obtained by the indicator value calculating portion in the example.

FIG. 11 is a diagram for explaining another example wherein the change rate of the indicator value is calculated through the application of the least-squares method as the smoothing process in the change rate calculating portion.

FIG. 12 is a diagram illustrating the state of calculation of the change rate of the indicator value by the change rate calculating portion in the another example.

FIG. 13 is a diagram illustrating changes in the change rate of the indicator value calculated by performing a smoothing process (the least-squares method) by the change rate calculating portion in the another example.

FIG. 14 is a block diagram illustrating certain portions of a pressure guiding tube blockage diagnosing device according to yet another example.

FIG. 15 is a diagram illustrating the relationships between methods for detecting blockages through the indicator values/change rates of the indicator value and the speed of progression of the blockages.

FIG. 16 is a diagram for explaining why variability is increased by taking differences.

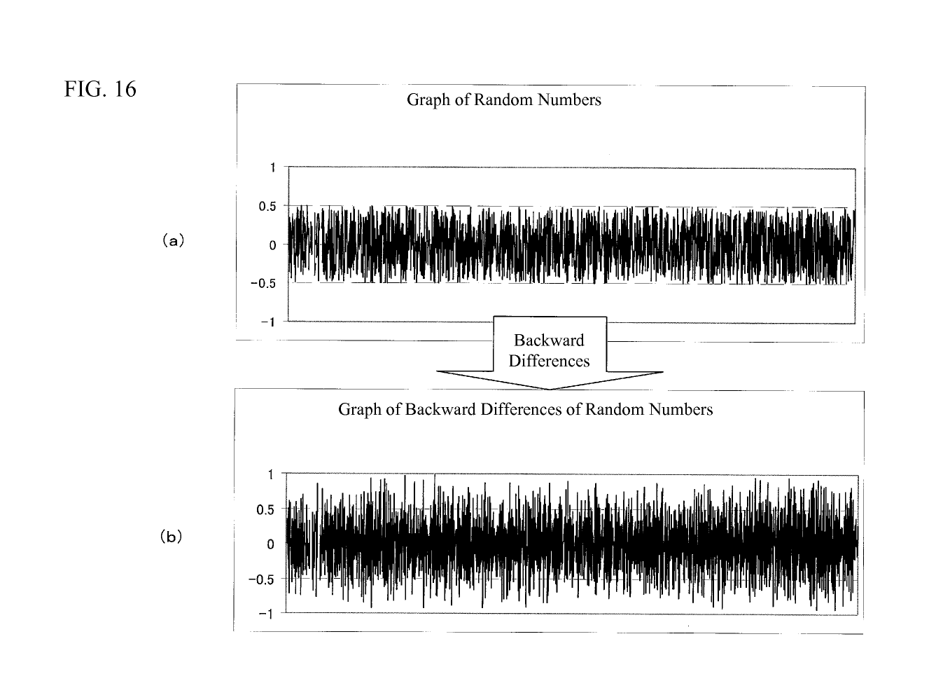

### DETAILED DESCRIPTION

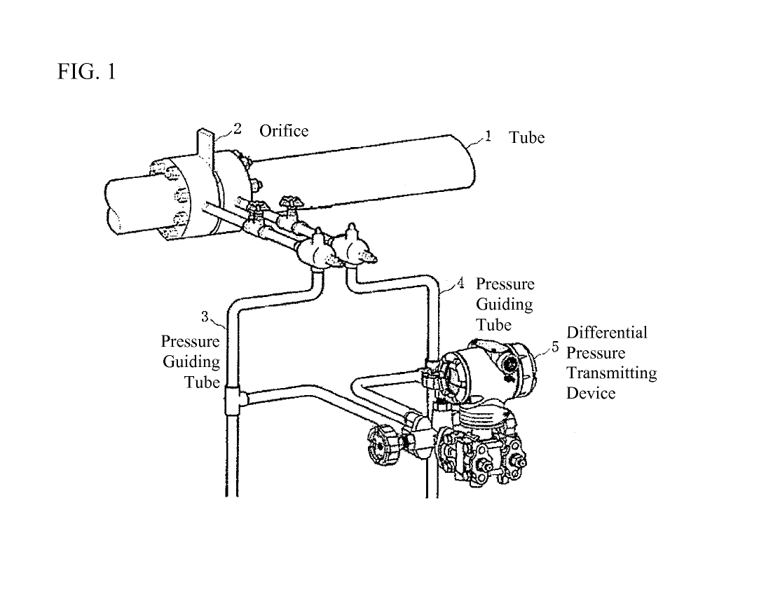

Examples of the present invention will be explained in detail below based on the drawings. FIG. 1 shows a schematic diagram of a differential pressure measuring system as one example of a system that uses a pressure guiding tube blockage diagnosing device according to the present invention. In this differential pressure measuring system, a differential pressure transmitting device 5 detects a pressure differential in a fluid that is guided through pressure guiding tubes 3 and 4 that branch from a process tube 1. Note that in this system an orifice 2 is provided in the process tube 1, and the pressure guiding tubes 3 and 4 branch from upstream and downstream locations with the orifice 2 therebetween.

### Example

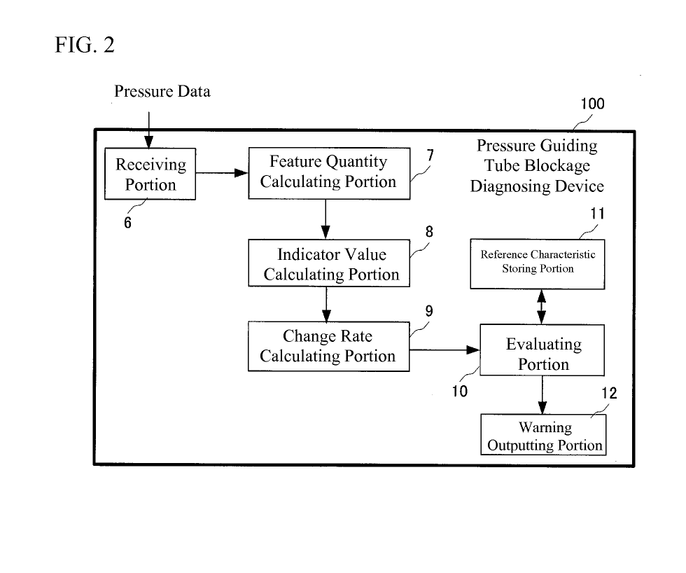

FIG. 2 shows a block diagram illustrating certain portions of an example of a pressure guiding tube blockage diagnosing device according to the present invention. This pressure guiding tube blockage diagnosing device 100 is provided with a receiving portion 6, a feature quantity calculating portion 7, an indicator value calculating portion 8, a change rate calculating portion 9, an evaluating portion 10, a reference characteristic storing portion 11, and a warning outputting portion 12.

The receiving portion 6 receives differential pressure data from the differential pressure transmitting device 5. The differential pressure data from the differential pressure transmitting device 5 corresponds to the pressure data from the pressure detecting portion as stated in the present invention. The feature quantity calculating portion 7 partitions the time series differential pressure data, received by the receiving portion 6, into a plurality of intervals and calculates, for each interval, a feature quantity indicating the state of fluctuation of the pressure therein. In the present example, the rising/falling frequencies of the fluctuations are calculated as the feature quantities. The method for calculating the rising/falling frequencies of the fluctuations is set forth as a specific method in the JP '893, already proposed by the present applicant, and thus the detailed explanation thereof is omitted here.

The indicator value calculating portion 8 obtains the feature quantities calculated by the feature quantity calculating portion 7, and for each individual interval, calculates, from the feature quantities for a given time interval up until that interval, an indicator value that indicates a state of blockage of the pressure guiding tubes. In the present example, an average (a moving average) of the feature quantities over the specific time interval is calculated as the indicator value.

The change rate calculating portion 9 obtains the indicator values calculated by the indicator value calculating portion 8, performs, for each individual interval, a smoothing process on the indicator values for a given time interval up until that interval, and calculates, from the indicator values on which the smoothing process has been performed, a change rate of the indicator values.

The “change rate of the indicator value” calculated by the change rate calculating portion 9 is not a simple change rate obtained from a difference in indicator values (a forward difference, a backward difference, or the like), but rather is a change rate calculated by performing a smoothing process on “indicator values” over a specific time interval (a specific number of samples or a specific interval). In the present example, the change rate calculating portion 9 calculates the change rate of the indicator value as follows.

(1) For the indicator values obtained from the indicator value calculating portion 8, a moving average process is performed as a smoothing process.

When the i^{th} indicator value is defined as x[i] (i=1, 2, 3, . . . ), The moving average number is defined as N, the j^{th} moving average value is defined as y[j] (j=N, N+1, N+2, . . . ), then y[j]=(x[j]+x[j−1]+x[j−2]+ . . . +x[j−N+1])/N.

(2) The backwards differences are calculated from the values obtained in (1), and defined as the change rate of the indicator value.

When the j^{th} moving average value is defined as y[j] (j=N, N+1, N+2, . . . ), and the k^{th} change rate of the indicator value is defined as z[k] (k=N, N+1, N+2, N+3, . . . ) then z[k]:=y[k]−y[k−1].

In the evaluating portion 10, the functions are different at the time of calculating reference characteristics and at the time of performing an evaluation, and operate as follows.

When Calculating the Reference Characteristics

(1) An average value μ and a standard deviation σ are calculated from the change rates of the indicator value obtained from the differential pressure data when no blockage has occurred.

(2) “μ−3σ” and “μ+3σ” are calculated from the average value μ and the standard deviation σ obtained in (1).

(3) “μ±3σ,” obtained in (2), is outputted as the reference characteristic to the reference characteristic storing portion 11.

When Performing an Evaluation

A check is performed as to whether or not the change rate of the indicator value obtained from the differential pressure data for which the evaluation as to whether or not there is a blockage is to be performed is within the range of the reference characteristic “μ±3σ,” obtained from the reference characteristic storing portion 11, to evaluate whether or not there is a change in the state of blockage of the pressure guiding tube. In this case, if the change rate of the indicator value is within the range of “μ±3σ,” then the evaluation is that “there is no change in the state of blockage of the pressure guiding tube,” but if the change rate of the indicator value is outside of the range of “μ±3σ,” then the evaluation is that “there is a change in the state of blockage of the pressure guiding tube.”

The reference characteristic storing portion 11, at the time at which the reference characteristic is calculated, stores the reference characteristic, “μ±3σ,” obtained from the evaluating portion 10, and, at the time at which the evaluation is performed, outputs, to the evaluating portion 10, the reference characteristic, “μ±3σ,” that was stored at the time at which the reference characteristic was calculated.

The warning outputting portion 12, upon an evaluation that “there is a change in the state of blockage of the pressure guiding tube,” based on the evaluation result by the evaluating portion 10, begins to output a blockage warning, and continues to output the blockage warning until the warning is resetted thereafter. When the blockage warning is outputted, this can be considered to be “abnormal (a blockage has occurred).” When the blockage warning is not outputted, this can be considered to be “normal (no blockage).”

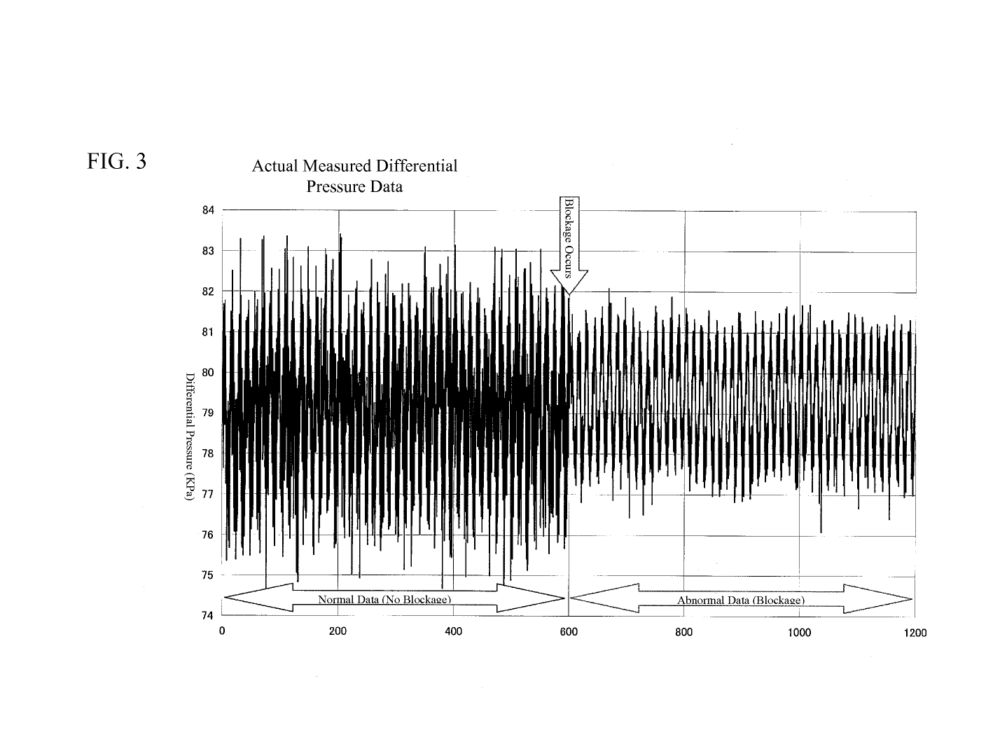

FIG. 3 shows actual differential pressure data measured when an artificial blockage occurred in the pressure guiding tube. In this differential pressure data, the 600 seconds of data in the first half is data for when there is no blockage (normal data), and the 600 seconds of data in the second half is data for when there is a blockage (abnormal data). Consequently, in this differential pressure data it can be seen that a blockage occurred in the 600th second of the data.

The pressure guiding tube blockage diagnosing device 100 receives such differential pressure data by the receiving portion 6, to diagnose the pressure guiding tube blockage. In the below, the situation wherein the pressure guiding tube blockage is diagnosed will be explained following the flow of calculations in the various portions in the pressure guiding tube blockage diagnosing device 100.

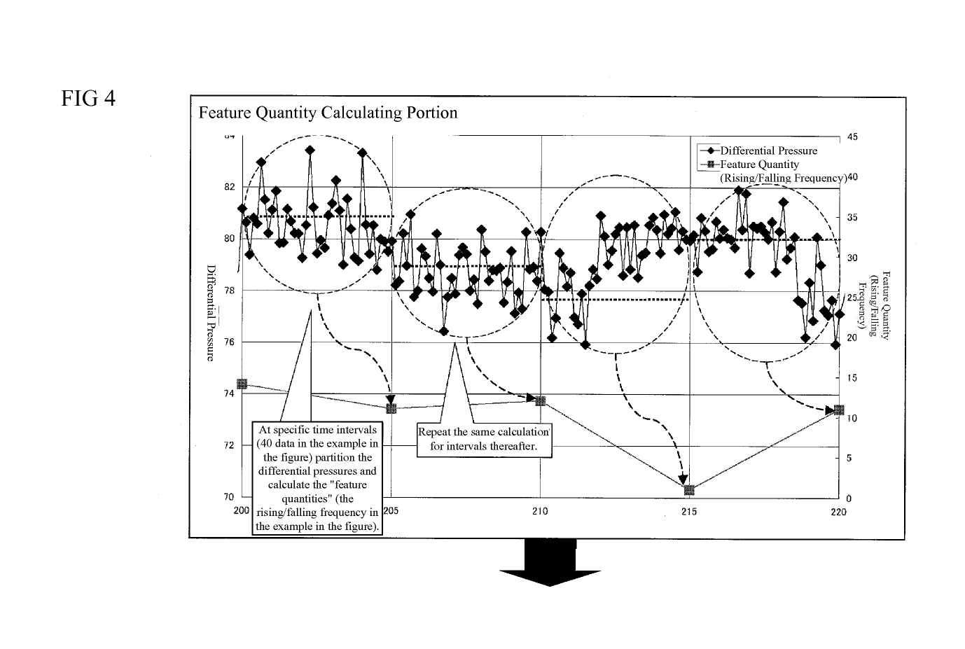

FIG. 4 is a diagram illustrating the state wherein feature quantities are calculated by the feature quantity calculating portion 7. The feature quantity calculating portion 7 partitions the time series of differential pressure data, received from the receiving portion 6, into a plurality of intervals, and calculates, for each interval, the rising/falling frequency of the fluctuations, as a feature quantity indicating the state of fluctuations in pressure therein. In this example, the differential pressure data were divided with 40 data in a single interval, and the rising/falling frequency of the fluctuation was calculated for each individual interval as the feature quantity. The feature quantities calculated by the feature quantity calculating portion 7 are sent to the indicator value calculating portion 8.

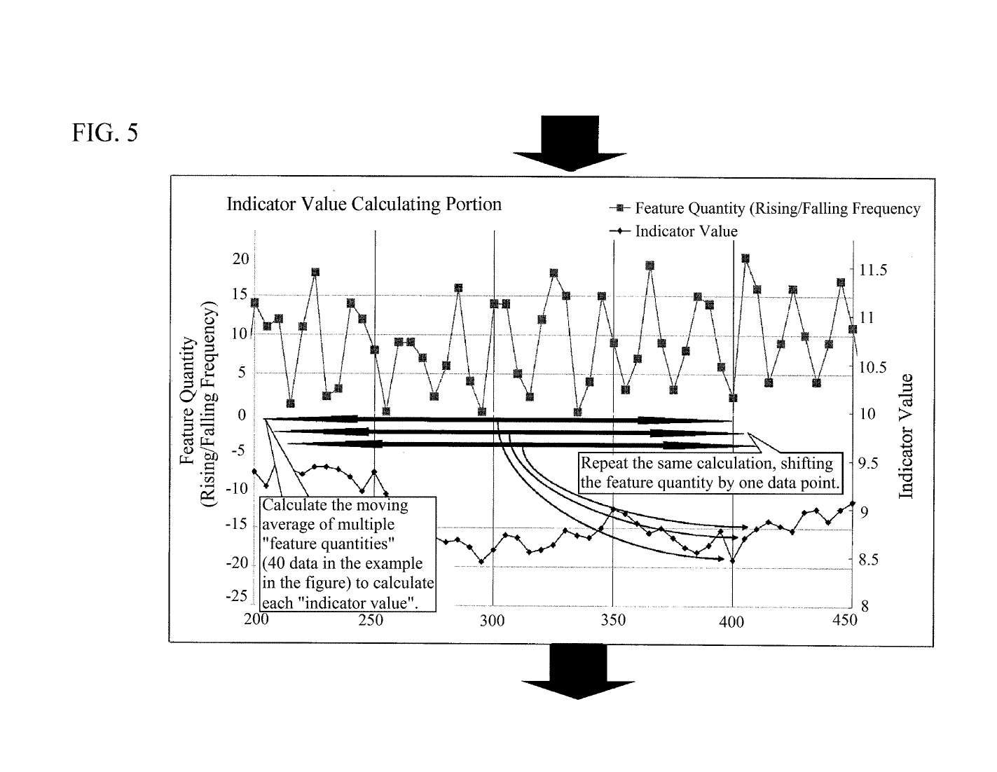

FIG. 5 is a diagram illustrating the state wherein indicator values are calculated by the indicator value calculating portion 8. The indicator value calculating portion 8 obtains the feature quantities calculated by the feature quantity calculating portion 7, and for each individual interval, calculates, from the feature quantities for a given time interval up until that interval, an indicator value that indicates a state of blockage of the pressure guiding tubes. In the current example, with 40 data as one interval, a plurality of feature quantities for each interval (40 data worth in the example in the figure) are averaged (in a moving average), and the average (moving average) is calculated as the indicator value. The indicator values calculated by the indicator value calculating portion 8 are sent to the change rate calculating portion 9.

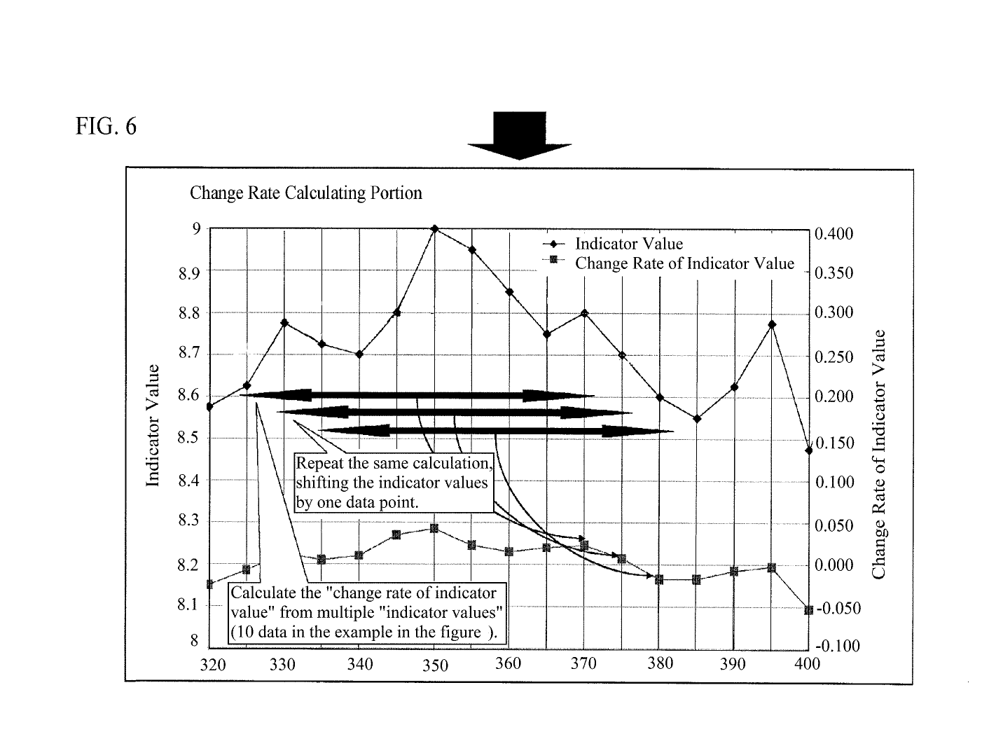

FIG. 6 is a diagram illustrating the state wherein change rates of the indicator value are calculated by the change rate calculating portion 9. The change rate calculating portion 9 obtains the indicator values calculated by the indicator value calculating portion 8, performs, for each individual interval, a smoothing process on the indicator values for a given time interval up until that interval, and calculates, from the indicator values on which the smoothing process has been performed, a change rate of the indicator values that indicates a change in the state of blockage of the pressure guiding tubes for the individual intervals. In the current example, with 40 data as one interval, an average (a moving average) is calculated for a plurality of indicator values for each interval (10 data worth in the example in the figure), and the difference from the average (moving average) for the indicator values of an adjacent interval, calculated in the same way, is calculated as the change rate of the indicator value for the interval. In this example, the adjacent interval is the backward interval, so the change rate of the indicator value is calculated as the backward difference.

The change rates of the indicator value calculated by the change rate calculating portion 9 are sent to the evaluating portion 10. The reference characteristic, “μ±3σ,” obtained at the time of calculation of the reference characteristic, is stored in the reference characteristic storing portion 11. The evaluating portion 10 reads in the reference characteristic, “μ±3σ,” that is, the average value±3σ for the normal data, which is stored in the reference characteristic storing portion 11, to check whether or not the change rate of the indicator value from the change rate calculating portion 9 is within the range of the reference characteristic “μ±3σ.” Here if the change rate of the indicator value is within the range of “μ±3σ,” then the evaluating portion 10 evaluates that “there is no change in the state of blockage of the pressure guiding tube,” but if the change rate of the indicator value is outside of the range of “μ±3σ,” then the evaluation is that “there has been a change in the state of blockage of the pressure guiding tube.”

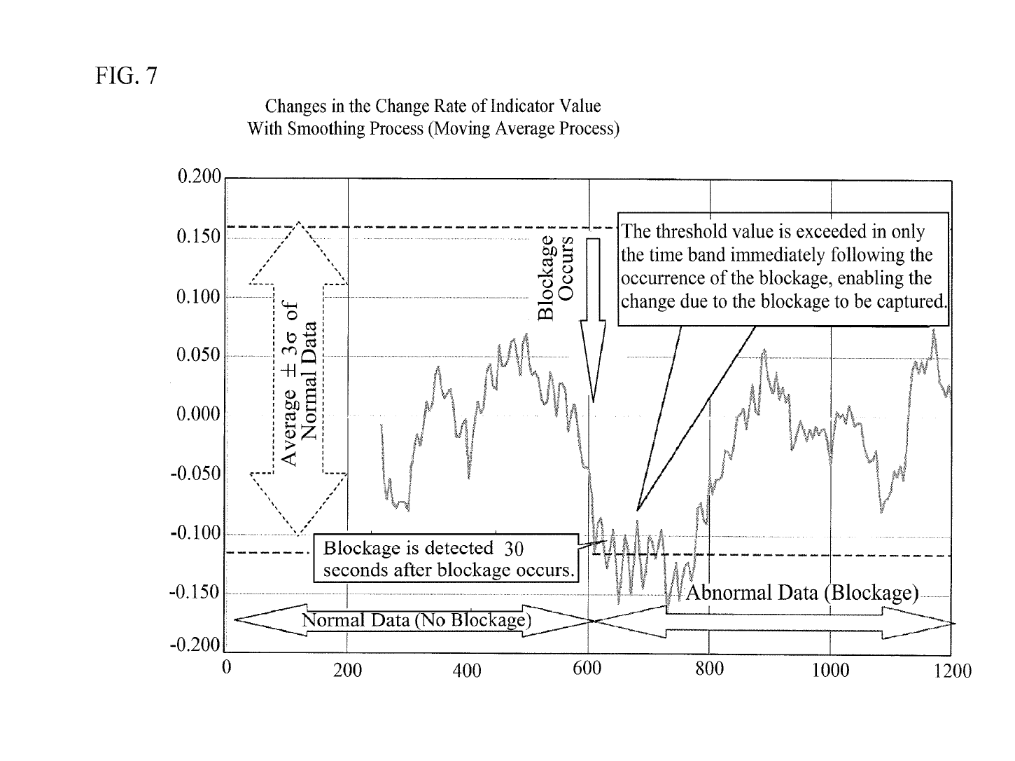

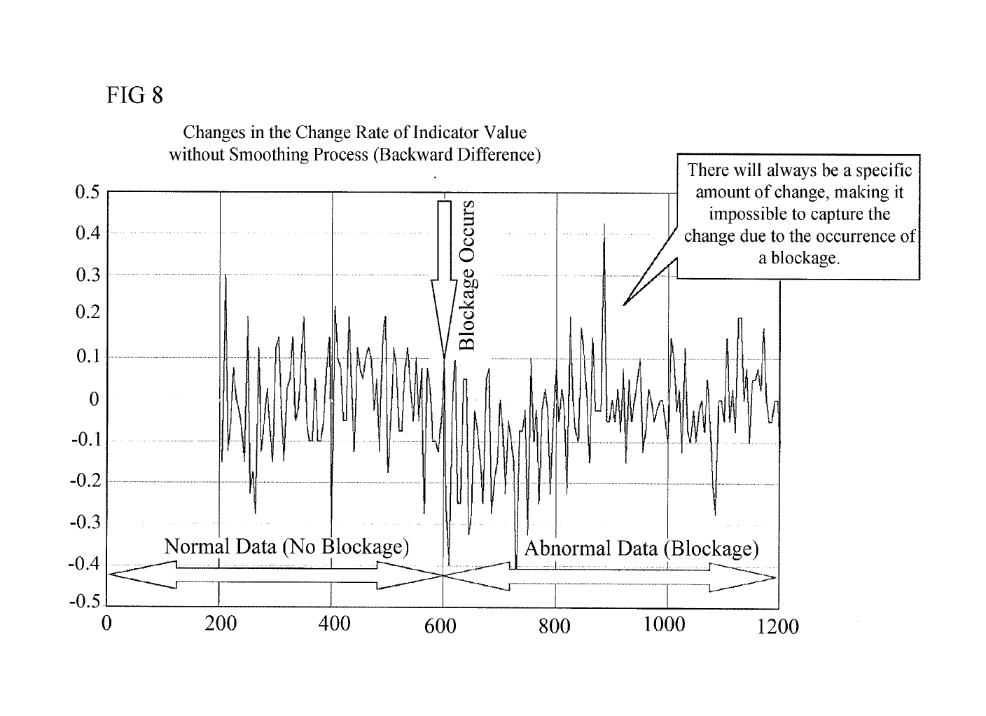

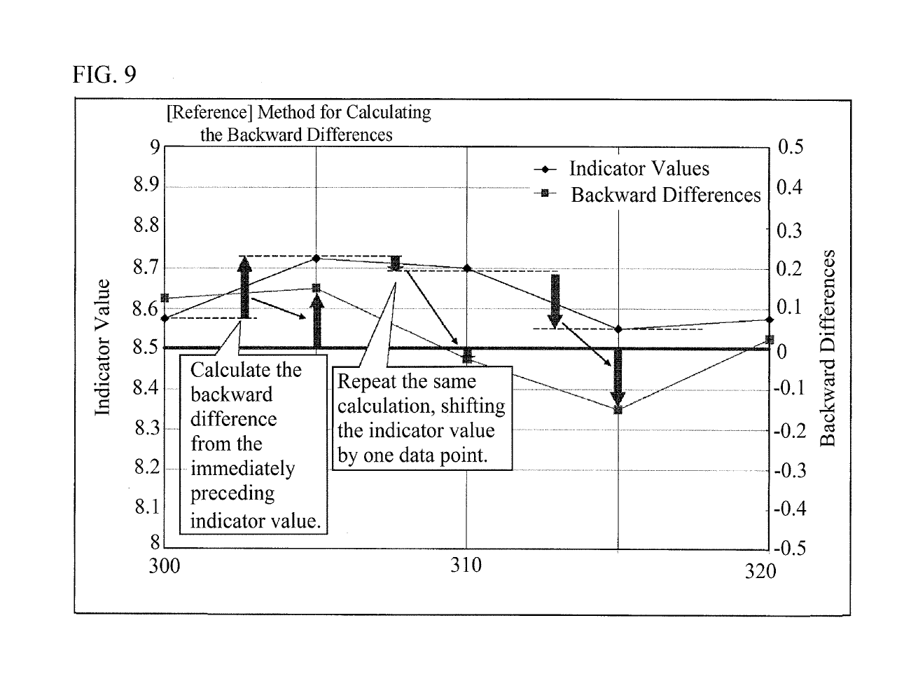

FIG. 7 shows changes in the change rate of the indicator value calculated by performing a smoothing process (a moving average process) by the change rate calculating portion 9. FIG. 8 shows changes in the change rate of the indicator value calculated as simple backward differences (referencing FIG. 9), without performing a smoothing process. When the change rate is calculated without performing a smoothing process, then, as illustrated in FIG. 8, there will always be a specific magnitude of change, and it will not be possible to capture changes due to the occurrence of a blockage. In contrast, when the change rate of the indicator value is calculated after performing a smoothing process (a moving average process), then, as illustrated in FIG. 7, a large change, exceeding the threshold value, will occur only in the time band immediately after the sudden occurrence of the blockage. In this example, the change rate of the indicator value is outside of the range of “μ±3σ,” and the blockage is detected, after 30 seconds after the occurrence of the blockage (the 630th second from the beginning of the data). In this case, there is a 30-second time lag from the occurrence of the blockage until the detection of the blockage.

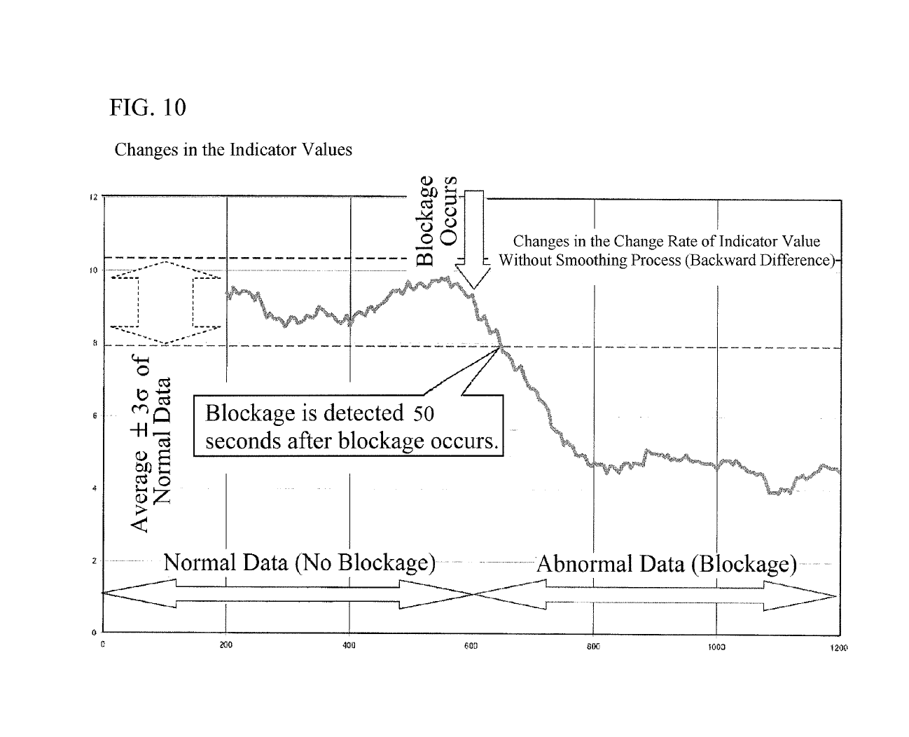

FIG. 10 shows the changes in the indicator values obtained by the indicator value calculating portion 8. The indicator values obtained from the indicator value calculating portion 8 continue in a falling trend from about 600 seconds until about 800 seconds, and around 800 seconds the falling trend stabilizes. If the detection of blockages was performed through the indicator values, it would take time until the effects of the blockage would be reflected in the indicator values, and it can be seen that there would be some degree of time lag from the occurrence of the blockage until the detection of the blockage.

For the indicator values, the average value ±3σ for the normal data is defined as a reference characteristic, and the evaluation is performed by defining a blockage as having occurred if the moving average value goes outside of the range of the average ±3σ of the normal data. In this case, after 50 seconds after the blockage has occurred (on the 650th second after the start of the data) the indicator values obtained from the indicator value calculating portion 8 go outside of the average value ±3σ of the normal data, and the blockage is detected. In this case, there is a 50-second time lag from the occurrence of the blockage until the detection of the blockage.

As can be understood by comparing the change in the change rate of the indicator value, shown in FIG. 7, to the change in the indicator value, shown in FIG. 10, the use of the change rate of the indicator value, produced by the change rate calculating portion 9, in the present example succeeds in reducing the time lag, from the occurrence of the blockage until the detection of the blockage, from 50 seconds to 30 seconds, successfully reducing the time lag to about 60% of that when the indicator value is used.

### Another Example

While in the above example the change rate of the indicator value was calculated using a moving average process as the smoothing process in the change rate calculating portion 9, in another example the change rate of the indicator value is calculated using the least-squares method as the smoothing process. Note that in the another example the difference is only in the process within the change rate calculating portion 9, and the structure is identical to that illustrated in FIG. 2. Because of this, the explanation in the another example as well will proceed using the structure illustrated in FIG. 2.

In the another example, the change rate calculating portion 9 applies the least-squares method as the smoothing process for the indicator values for the specific time interval up until the given interval, for each interval, for the indicator values obtained from the indicator value calculating portion 8, where the slope of the line obtained is defined as the change rate of the indicator value for the interval.

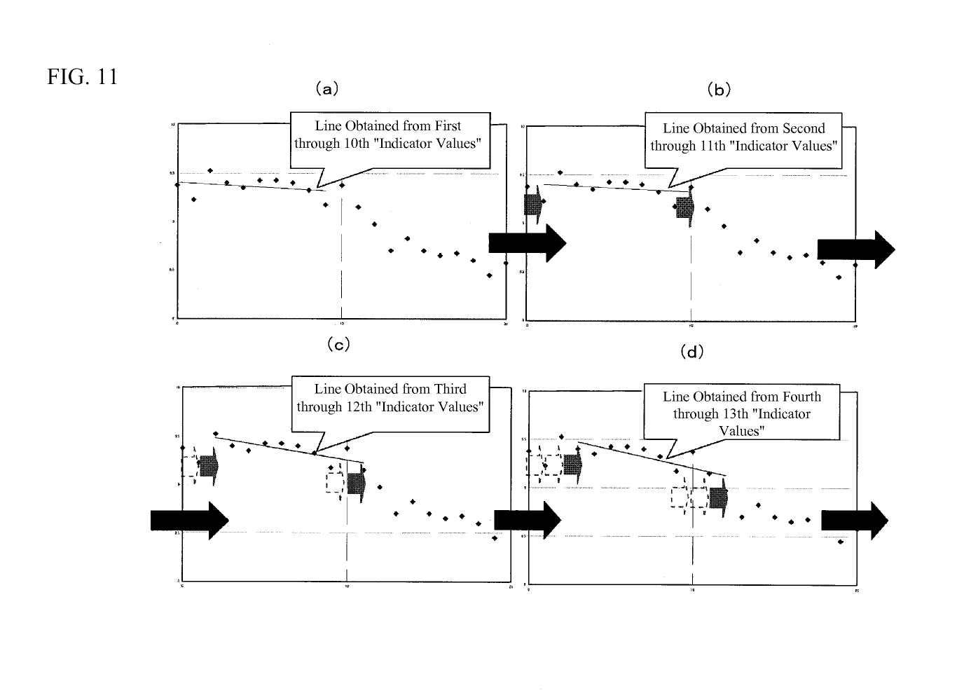

An example of a case wherein the change rate of the indicator value is calculated through the application of the least-squares method is illustrated in FIG. 11. In this example, the specific time interval is defined as a set of 10 data, and the least-squares method is applied, as the smoothing process, to the indicator values for the that set of 10 data.

When the least-squares method is applied to the first through 10th indicator values, the line that is shown by the solid line in FIG. 11(a) is produced. Similarly, when the least-squares method is applied while shifting the indicator value by one data at a time, lines as in FIG. 11(b) through (d) are produced.

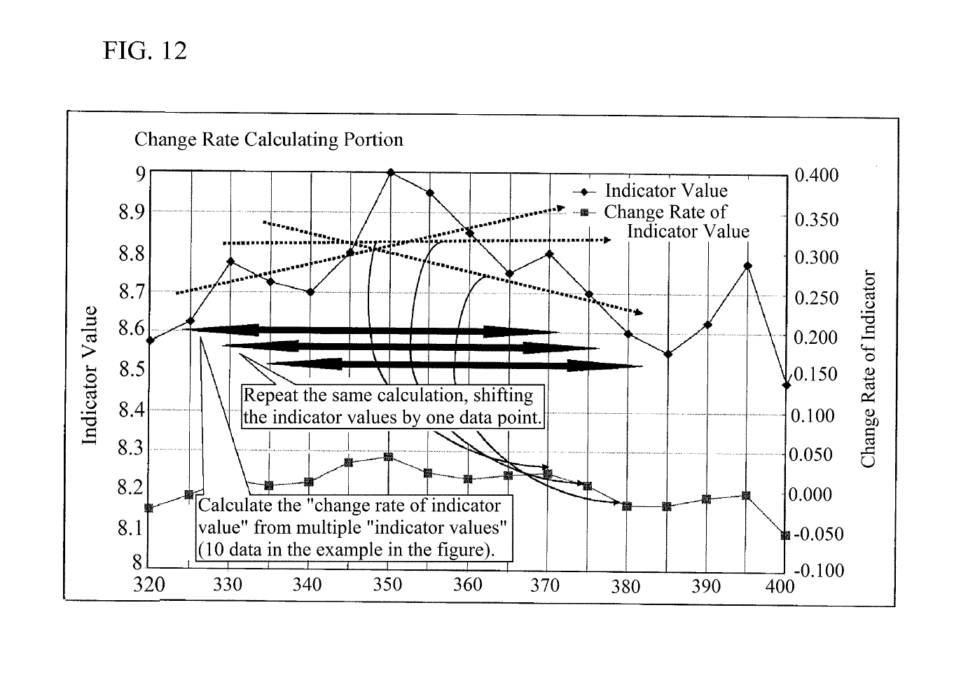

Even for the data thereafter, the same process is repeated, shifting by one data each time. The slopes of the lines produced in this way are used as the change rate of the indicator value. The state of calculation of the change rate of the indicator value by the change rate calculating portion 9 in the another example is shown in FIG. 12.

The change rates of the indicator value calculated by the change rate calculating portion 9 are sent to the evaluating portion 10. The reference characteristic, “μ±3σ,” obtained at the time of calculation of the reference characteristic, is stored in the reference characteristic storing portion 11. The evaluating portion 10 reads in the reference characteristic, “μ±3σ,” that is, the average value ±3σ for the normal data, which is stored in the reference characteristic storing portion 11, to check whether or not the change rate of the indicator value from the change rate calculating portion 9 is within the range of the reference characteristic “μ±3σ.” Here if the change rate of the indicator value is within the range of “μ±3σ,” then the evaluating portion 10 evaluates that “there is no change in the state of blockage of the pressure guiding tube,” but if the change rate of the indicator value is outside of the range of “μ±3σ,” then the evaluation is that “there has been a change in the state of blockage of the pressure guiding tube.”

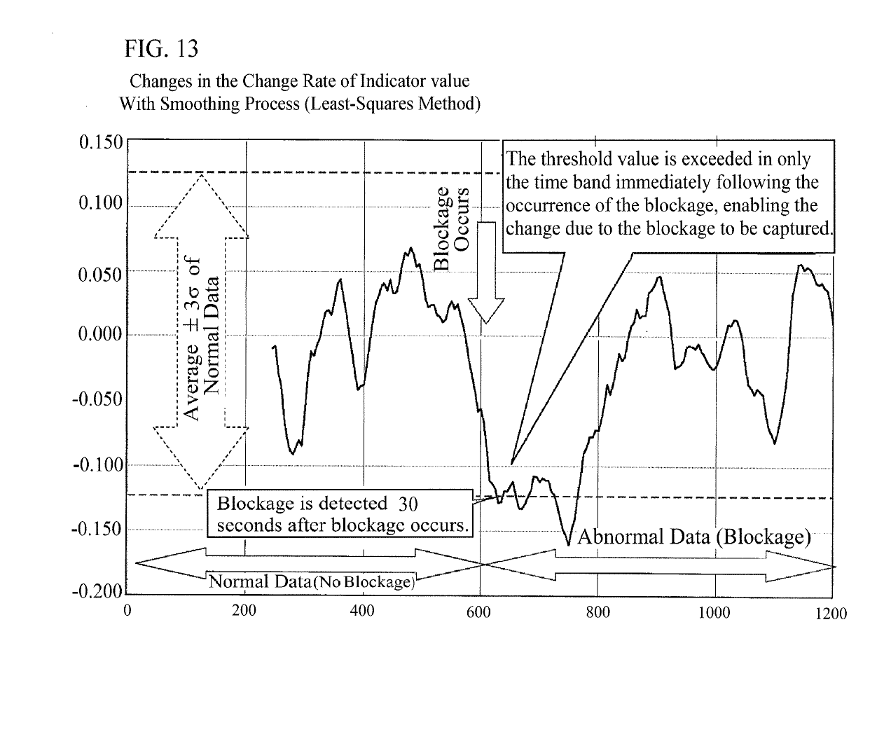

FIG. 13 shows changes in the change rate of the indicator value calculated by performing a smoothing process (the least-squares method) by the change rate calculating portion 9 in the another example. As explained in the example as well, when the change rate is calculated without performing a smoothing process (referencing FIG. 8), there will always be a specific magnitude of change, and it will not be possible to capture changes due to the occurrence of a blockage. In contrast, when the change rate of the indicator value is calculated after performing a smoothing process (the least-squares method), then, as illustrated in FIG. 13, a large change, exceeding the threshold value, will occur only in the time band immediately after the sudden occurrence of the blockage. In this example, the change rate of the indicator value is outside of the range of “μ±3σ,” and the blockage is detected, after 30 seconds after the occurrence of the blockage (the 630th second from the beginning of the data). In this case, there is a 30-second time lag from the occurrence of the blockage until the detection of the blockage.

As can be understood by comparing the change in the indicator value, shown in FIG. 10, in the another example as well the use of the change rate of the indicator value, produced by the change rate calculating portion 9, succeeds in reducing the time lag, from the occurrence of the blockage until the detection of the blockage, from 50 seconds to 30 seconds, successfully reducing the time lag to about 60% of that when the indicator value is used.

### Yet Another Example

While in the example and the another example the evaluation of whether or not there is a blockage in a pressure guiding tube was performed using only the change rate of the indicator value, produced by the change rate calculating portion 9, in yet another example an evaluation using the change rate of the indicator value, produced by the change rate calculating portion 9, and an evaluation using the indicator value produced by the indicator value calculating portion 8 are combined.

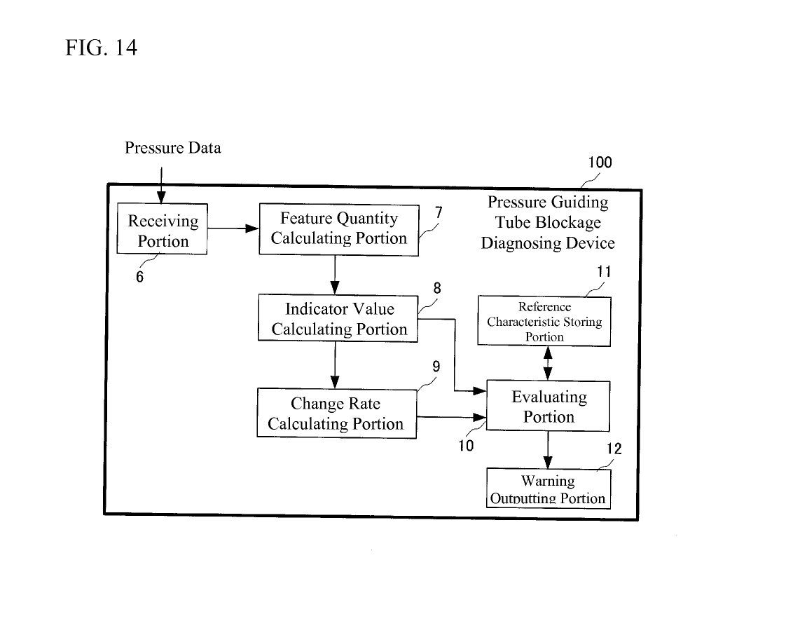

FIG. 14 shows a block diagram of certain portions of a pressure guiding tube blockage diagnosing device 100 according to the yet another example. In the yet another example, rather than just the change rates of the indicator value, produced by the change rate calculating portion 9, the indicator values produced by the indicator value calculating portion 8 are also sent to the evaluating portion 10.

In the evaluating portion 10, the functions are different at the time of calculating reference characteristics and at the time of performing an evaluation, and operate as follows.

When Calculating the Reference Characteristics

(1) An average value μ and a standard deviation σ are calculated from the change rates of the indicator value obtained from the differential pressure data when no blockage has occurred.

(2) “μ−3σ” and “μ+3σ” are calculated from the average value μ and the standard deviation σ obtained in (1).

(3) An average value μ′ and a standard deviation σ′ are calculated from the indicator values obtained from the differential pressure data when no blockage has occurred.

(4) “μ′−3σ′” and “μ′+3σ′” are calculated from the average value μ′ and the standard deviation σ′ obtained in (3).

(5) “μ±3σ,” obtained in (2), and “μ′±3σ′,” obtained in (4), are outputted as reference characteristics to the reference characteristic storing portion 11.

When Performing an Evaluation

A check is performed as to whether or not the change rate of the indicator value obtained from the differential pressure data for which the evaluation as to whether or not there is a blockage is to be performed is within the range of the reference characteristic “μ±3σ,” obtained from the reference characteristic storing portion 11, and a check is performed as to whether or not the indicator value obtained from the differential pressure data for which the evaluation as to whether or not there is a blockage is to be performed is within the range of the reference characteristic “μ′±3σ′,” to evaluate whether or not there is a blockage of a pressure guiding tube.

In this case, if the change rate of the indicator value is within the range of “μ±3σ” and the indicator value is within the range of “μ′±3σ′,” then the evaluation is “Normal (there is no change in the state of blockage of the pressure guiding tube, and no blockage has occurred),” but otherwise, that is, if the change rate of the indicator value is outside of the range of “μ±3σ” or the indicator value is outside of the range of “μ′±3σ′,” then the evaluation is “Abnormal (there is a change in the state of blockage of a pressure guiding tube or a blockage has occurred).”

In the yet another example, the reason for using the change rate of the indicator value together with the indicator value is that if the progression of the blockage is gradual it cannot be detected by the change rate of the indicator value, so it is necessary to perform the evaluation using the indicator value. The use of the change rate of the indicator value in addition to the use of the indicator value, makes it possible to detect more quickly blockages over a wider range regardless of whether the progression of the blockage is slow or fast.

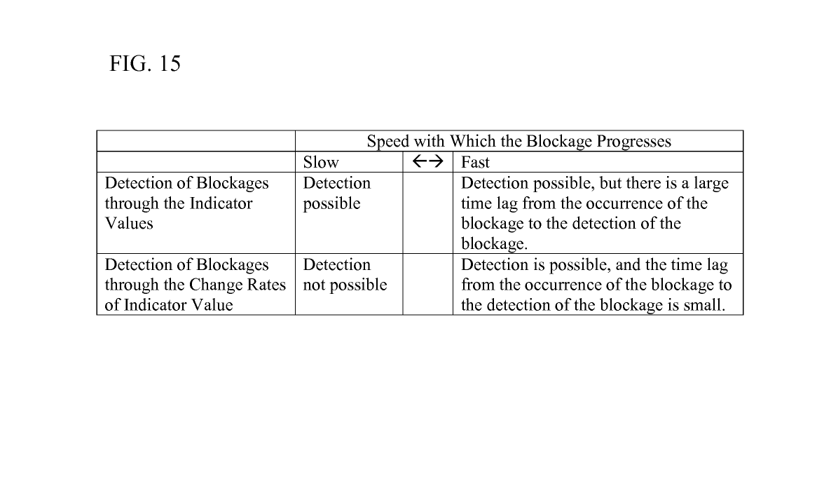

FIG. 15 shows the relationships between methods for detecting blockages through the indicator values/change rates of the indicator value and the speed of progression of the blockages. While, with a method for detecting blockages using the change rate of the indicator value, it is possible to detect quickly a case wherein the progression of the blockage of a pressure guiding tube is rapid, cases wherein the progression is slow cannot be detected. On the other hand, while, with a method for detecting blockages using the indicator values, it is possible to detect a case wherein the blockage of a pressure guiding tube is slow, for cases wherein the progression is fast, detection, although possible, will be slow. Using two types of blockage detecting methods together makes it possible to compensate for the shortcomings, and to take advantage of the strengths, of each. Note, however, that the evaluating portion 10 using the indicator values as well is, in the end, merely one example of the present invention, and is not an essential constituent element of the present invention.

Note that while in the examples set forth above the explanations were for examples wherein a differential pressure transmitter was used as the pressure detecting portion and differential pressure data was received by the receiving portion from the differential pressure transmitter, instead the diagnosis of blockage of the pressure guiding tube can be performed similarly also in the case wherein a pressure transmitting device is used as the pressure detecting portion and pressure data is received, by the receiving portion, from the pressure transmitting device.

Moreover, while in the examples set forth above the explanation was for an example wherein a pressure transmitting device or differential pressure transmitting device was used as the pressure detecting portion and data from these transmitting devices was received by a receiving portion of a pressure guiding tube blockage diagnosing device that is external to the transmitting device, instead a pressure sensor or differential pressure sensor internal to the transmitting device may be used as pressure detecting portion, and the output of that sensor may be received by a receiving portion within the transmitting device, and some or all of the calculations may be performed within the transmitting device.

Moreover, while in the examples set forth above the explanation was for an example of a method that used, as the feature quantity, the rising/falling frequency of the pressure, as set forth in the JP '893, and that made the feature quantities into indicator values, the example of the present invention is not limited to this method. The present invention can be applied insofar as the indicator values for the pressure guiding tube blockage is are based on pressure fluctuations, and indicator values that have been used in conventional methods, such as sums of squares of first-order difference fluctuations or sums of squares of second-order difference fluctuations or differences between maximum values and minimum values of pressures or differential pressures, may be used instead.

For example, there are the following examples of “feature quantities,” “indicator values,” “change rates of indicator value,” and “reference characteristics.”
Examples of “feature quantities”: Rising/falling frequencies of fluctuations, first-order difference fluctuations, second-order difference fluctuations, and fluctuation amplitude magnitudes.
Examples of “indicator values”: for fluctuations included in samples over specific time intervals, moving averages of rising/falling frequencies, average sums of squares of first-order difference fluctuations, average sums of squares of second-order difference fluctuations, fluctuation distributions, differences between maximum values and minimum values, and magnitudes of power spectrum high-frequency components.
Examples of “change rates of indicator value”: Slopes of data when a simple moving average process has been performed, slopes of data when a weighted moving average process has been performed, slopes of lines calculated through the least-squares method, slopes of data smoothed through spline functions or Gaussian functions, slopes (change rates) of differences between maximum values and minimum values, and slopes (change rates) of magnitudes of power spectrum high-frequency components.
Examples of “reference characteristics”: Maximum values, minimum values, and average values ±3× standard deviations, of “change rates of indicator value.”

### Extended Examples

While the present invention has been explained above in reference to examples, the present invention is not limited to the examples set forth above. The structures and details in the present invention may be varied in a variety of ways, as can be understood by one skilled in the art, within the scope of technology in the present invention.

1: A pressure guiding tube blockage diagnosing device for diagnosing a blockage in a pressure guiding tube for guiding, to a pressure detecting portion, a pressure to be measured, wherein there are fluctuations in the pressure, the device comprising:
a receiving portion that receives pressure data from the pressure detecting portion;
a feature quantity calculating portion that partitions a time series of pressure data, received by the receiving portion, into a plurality of intervals, and calculates, for each interval, a feature quantity indicating the state of fluctuation of the pressure;
an indicator value calculating portion that calculates, for each individual interval, an indicator value that indicates a state of blockage of the pressure guiding tubes, from the feature quantities for a given time interval up until that interval;
a change rate calculating portion that performs, for each interval, a smoothing process on the indicator values over a specific time interval up to that interval, and calculates, from the indicator values that have been subjected to the smoothing process, a change rate for the indicator values for each interval; and
an evaluating portion that evaluates the state of blockage of a pressure guiding tube based on a change rate of the indicator value calculated by the change rate calculating portion.

2: The pressure guiding tube blockage diagnosing device as set forth in claim 1, wherein
the change rate calculating portion calculates the change rate of the indicator value using a moving average process as the smoothing process.

3: The pressure guiding tube blockage diagnosing device as set forth in claim 1, wherein
the change rate calculating portion calculates the change rate of the indicator value using the least-squares method as the smoothing process.

4: The pressure guiding tube blockage diagnosing device as set forth in claim 1, wherein
the evaluating portion evaluates a state of blockage of a pressure guiding tube based on a change rate of the indicator value calculated by the change rate calculating portion and on an indicator value calculated by the indicator value calculating portion.

5: A pressure guiding tube blockage diagnosing method for diagnosing a blockage in a pressure guiding tube for guiding, to a pressure detecting portion, a pressure to be measured, wherein there are fluctuations in the pressure, the method comprising:
a receiving step for receiving pressure data from the pressure detecting portion;
a feature quantity calculating step for partitioning a time series of pressure data, receive in the receiving step, into a plurality of intervals, and for calculating, for each interval, a feature quantity indicating the state of fluctuation of the pressure;
an indicator value calculating step for calculating, for each individual interval, an indicator value that indicates a state of blockage of the pressure guiding tubes, from the feature quantities for a given time interval up until that interval;
a change rate calculating step for performing, for each interval, a smoothing process on the indicator values over a specific time interval up to that interval, and for calculating, from the indicator values that have been subjected to the smoothing process, a change rate for the indicator values for each interval; and
an evaluating step for evaluating the state of blockage of the pressure guiding tube based on the change rate of the indicator value calculated in the change rate calculating step.

6: The pressure guiding tube blockage diagnosing method as set forth in claim 5, wherein
the change rate calculating step calculates the change rate of the indicator value using a moving average process as the smoothing process.

7: The pressure guiding tube blockage diagnosing method as set forth in claim 5, wherein
the change rate calculating step calculates the change rate of the indicator value using the least-squares method as the smoothing process.

8: The pressure guiding tube blockage diagnosing method as set forth in claim 5, wherein
the evaluating step evaluates a state of blockage of a pressure guiding tube based on a change rate of the indicator value calculated by the change rate calculating step and on an indicator value calculated by the indicator value calculating step.
